(19) United States
(12) Patent Application Publication
(10) Pub. No.: US 2017/0106415 A1
(43) Pub. Date: Apr. 20, 2017

(54) SYSTEM AND METHOD FOR FLUSHING A PUMP

(71) Applicant: Caterpillar Inc., Peoria, IL (US)

(72) Inventors: Derek Waldschmidt, Peoria, IL (US); Gunasekar Thangarasu, Chennai (IN)

(73) Assignee: Caterpillar Inc., Peoria, IL (US)

(21) Appl. No.: 14/884,881

(22) Filed: Oct. 16, 2015

(51) Int. Cl. B08B 9/093; B08B 3/14

(52) U.S. Cl. CPC B08B 9/0933; B08B 3/14

(57) ABSTRACT

A system for flushing a pump including a reservoir for a fluid, a filter in fluid communication with the reservoir, the filter having an outlet for providing clean fluid to a pump for a flushing operation, and a power source having a first driving shaft for pumping the fluid from the reservoir to the filter and a second driving shaft for driving the pump during the flushing operation.

### TECHNICAL FIELD

The present disclosure relates generally to fluid pumps. In particular, the present disclosure relates to a pump flushing system.

### BACKGROUND

Fluid pumps are widely used to pump a variety of fluids for many different applications. During operation, pumps may get clogged with the impurities or other particulate matter present in the fluid. These particles may deposit on parts of the pump and may form a sludge within the pump. The sludge inside the pump may affect normal operation and may reduce efficiency of the pump.

Pumps may sometimes be cleaned by disassembling parts of the pump. Flushing of the pump is done when the pump is to be cleaned without disassembly. Conventional flushing methods use a fresh cleaning fluid that is pumped through the pump with the dirty fluid collected from the pump.

Suitable jigs and fixtures may be required for the pump flushing operation depending on where the pump is fitted and the type of pump being flushed. In addition, where the pump to be flushed is associated with a machine, it may be necessary for the machine to run during the flushing operation in order to power the pump. Further, during the flushing operation the pump being flushed is run at its normal operating capacity, which may not be adequate for effectively removing the debris and deposits on the pump parts.

There are a variety of known pump flushing solutions. U.S. Pat. No. 2,372,538 discloses one example, which provides for one or more nozzles fitted into a pump casing for flushing a centrifugal pump with a cleaning fluid. The present invention addresses one or more issues associated with known pump flushing solutions.

### SUMMARY OF THE INVENTION

A system for flushing a pump including a reservoir for a fluid, a filter in fluid communication with the reservoir, the filter having an outlet for providing clean fluid to a pump for a flushing operation, and a power source having a first driving shaft for pumping the fluid from the reservoir to the filter and a second driving shaft for driving the pump during the flushing operation.

A system for flushing a pump including a platform, a reservoir for a fluid, a filter in fluid communication with the reservoir, the filter having an outlet for providing clean fluid to a pump for a flushing operation and a power source mounted on the platform and having a first driving shaft and a second driving shaft, the second driving shaft configured to drive a second pump for the flushing operation. The system further includes a first pump connected to the first driving shaft for pumping the fluid from the reservoir to the filter for the flushing operation.

A method of flushing a pump including pumping flushing fluid from a reservoir to a filter for cleaning the fluid using a first pump, conveying clean fluid from the filter to a second pump for its flushing operation and driving the first pump by a first driving shaft of a power source and driving the second pump by a second driving shaft of the power source.

### BRIEF DESCRIPTION OF THE DRAWINGS

FIG. 1 illustrates a perspective view of a system for flushing a pump.

FIG. 2 illustrates a schematic diagram of the system illustrated in FIG. 1.

FIG. 3 illustrates a perspective view of a system for flushing a pump.

FIG. 4 illustrates a schematic diagram of the system illustrated in FIG. 3

FIG. 5 illustrates a schematic diagram of a method of flushing a pump.

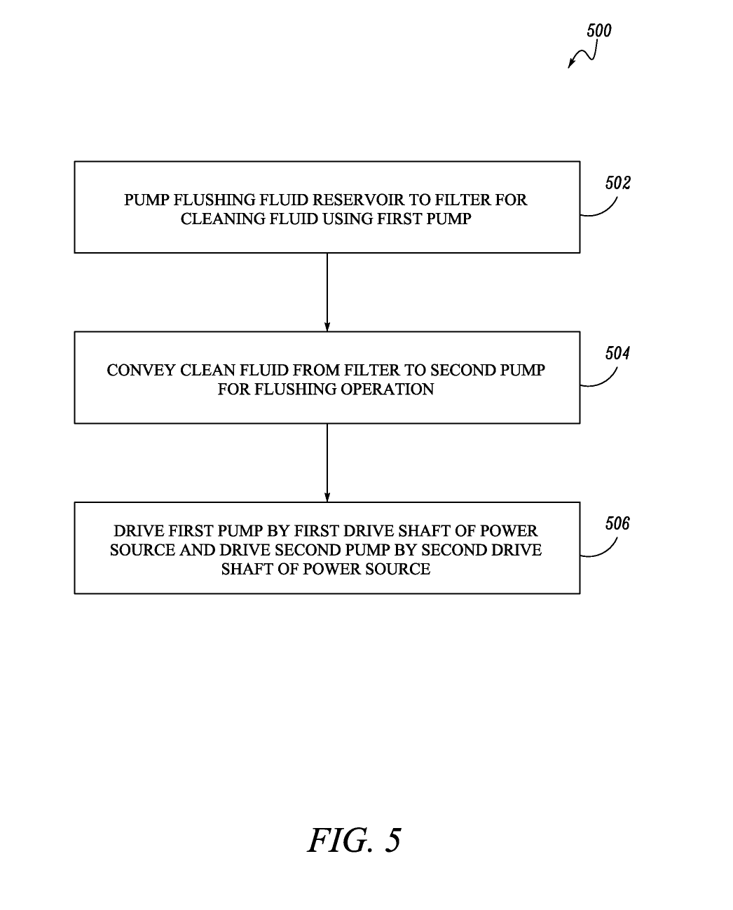

### DETAILED DESCRIPTION

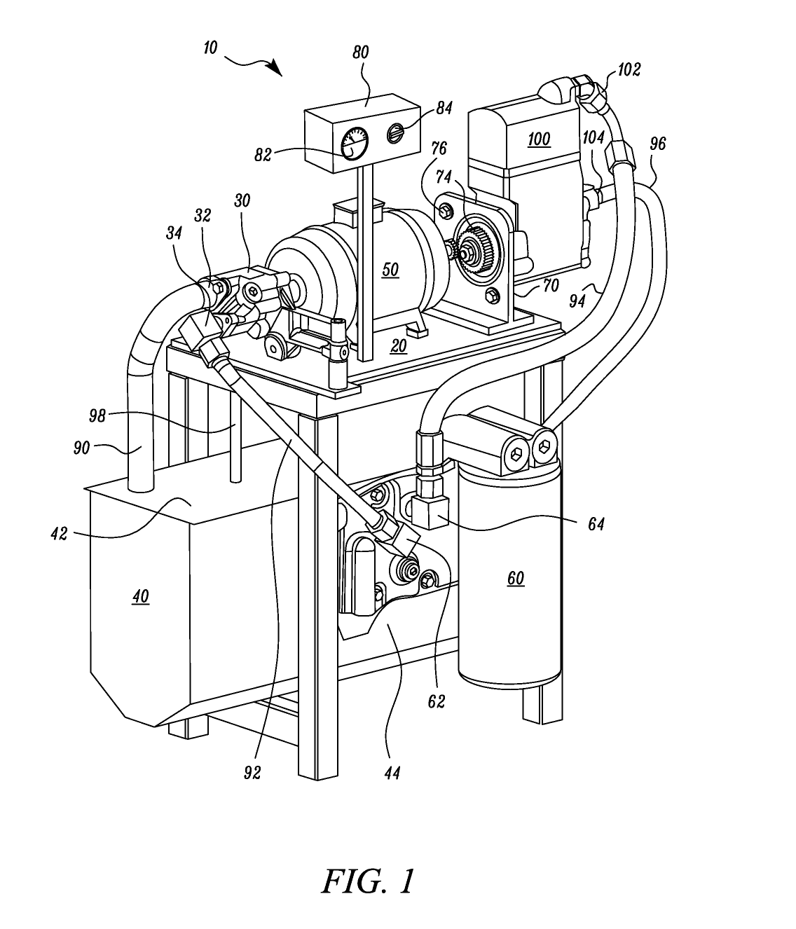

FIG. 1 illustrates an exemplary system 10 for flushing a pump. The system 10 includes a first pump 30, a reservoir 40, a power source 50, a filter 60, a pump mounting structure 70 and a platform 20. The first pump 30, the reservoir 40, the power source 50, the filter 60 and the pump mounting structure 70 may be mounted on the platform 20.

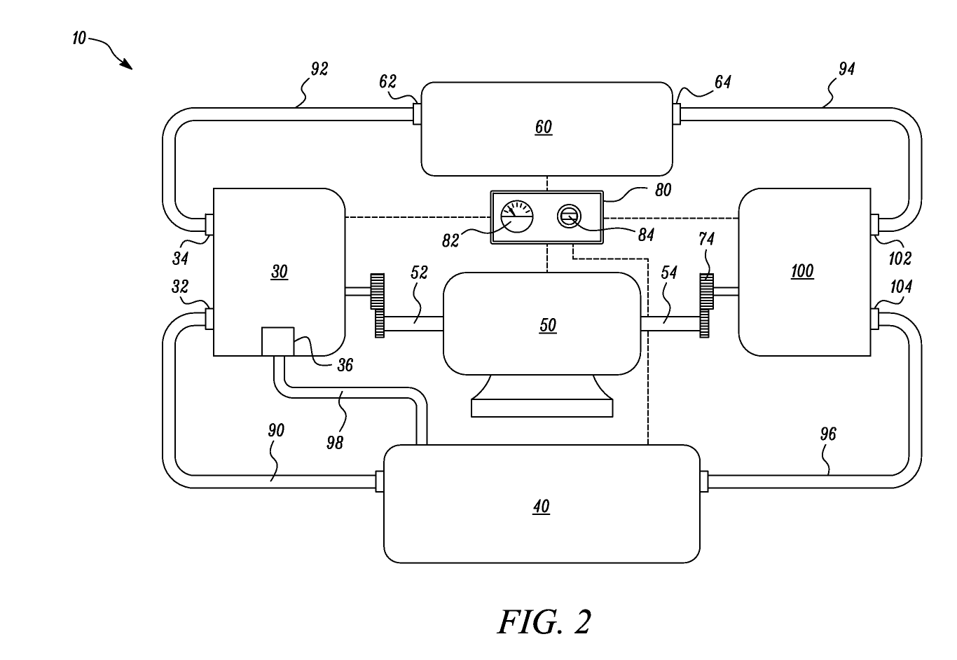

Referring to FIG. 2, the first pump 30 is configured to pump a fluid from the reservoir 40 to the filter 60 at a high pressure. The first pump 30 may be any pump know in the art. In the embodiment illustrated in FIG. 2 the first pump 30 may have a first pump inlet 32 and a first pump outlet 34. Further, the fluid pumped by the first pump may be any fluid suitable for flushing a pump.

The first pump 30 may be coupled to the power source 50 for running the first pump 30. A variable gear drive may be used to couple the first pump 30 to the power source 50. The power source 50 may be any known power source suitable for the disclosed application. For example, the power source 50 may include a conventional internal combustion engine or an electric motor. In the embodiment as illustrated, the power source 50 is an electric motor.

The first pump 30 is configured to pump a flushing fluid from the reservoir 40 to the filter 60 for cleaning The filter 60 may have a filter inlet 62 and a filter outlet 64. The first pump inlet 32 may be fluidly coupled to the reservoir 40 by a reservoir conduit 90. The first pump outlet 34 may be coupled to the filter inlet 62 using supply conduit 92. The first pump 30 may supply fluid from the reservoir 40 to the filter 60.

The filter 60 may be configured to filter or clean the fluid received from the first pump 30 for removing any contaminants or particulate matters from the fluid. The filter 60 may be any filter known in the art suitable for the purpose. After passing through the filter 60 the filtered or clean fluid may be directly conveyed to a pump to be flushed. In the embodiment as illustrated in FIG. 1, a second pump 100 is the pump being flushed.

The second pump 100 may be coupled to the system 10 using the pump mounting structure 70. The pump mounting structure 70 may have a mounting arrangement for mounting the second pump 100 to the pump mounting structure 70. The second pump 100 may be mounted on the pump mounting structure 70 via any arrangement known in the art. In the embodiment as illustrated, the second pump 100 is attached to a bracket of the pump mounting structure 70 with bolts 76. The bracket may be adjustable for different pump sizes.

The pump being flushed may be coupled to the power source 50 using a suitable coupling arrangement. In the embodiment as illustrated, a gear drive is used. The gear drive may be a variable gear drive. As illustrated schematically in FIG. 2, the pump mounting structure 70 may have a gear arrangement 74 for coupling the second pump 100 with a second shaft 54 coupled to the power source 50. The second pump 100 may be required to run at a different rotation speed compared to the first pump 30. The gear arrangement 74 with the pump mounting structure 70 may provide for achieving required rotation speed for the second pump 100. The gear arrangement 74 may have set of interchangeable gears. The gear arrangement 74 may be adjusted for coupling different type of pumps to the power source 50. The power source 50 may be coupled to the first pump 30 by a first shaft 52 and the second pump 100 by a second shaft 54 using gear arrangement 74. The power source 50 may run both the pumps 30, 100 at the same time. In an embodiment, the first pump 30 may be coupled directly to the first shaft 52 of the power source. In an embodiment, the first shaft 52 may be same as the second shaft 54. In other embodiments, the first shaft 52 and the second shaft 54 may be differently sized. In another embodiment, the pumps 30,100 may be coupled to the power source 50 using any other mechanisms known in the art, for example a pulley and belt mechanism.

The second pump 100 may be any pump that is required to be flushed. In the embodiment as illustrated in FIG. 2, the second pump 100 may be an axial piston pump. The second pump 100 may have a second pump inlet 102 and a second pump outlet 104. The second pump inlet 102 may be fluidly coupled to the filter outlet 64 by a delivery conduit 94 and the second pump outlet 104 is coupled to the reservoir 40 by a return conduit 96. The second pump inlet 102 may receive fluid at a high pressure from the filter outlet 64. The second pump 100 may be run by the power source 50 at a suitable speed to enable flow of fluid in the second pump 100 for flushing the second pump 100. The flushed fluid being expelled from the second pump 100 may be conveyed to the reservoir 40 via return conduit 96. Flushing operation of the second pump 100 with the high pressure fluid pumped by the first pump 30 may remove any sludge or deposits from the second pump 100. The high pressure fluid received may provide for a forced flow with greater force inside the second pump 100 compared to normal operational capacity of the second pump 100. This way the second pump 100 may be flushed more effectively. Further, the system 10 may be run for a suitable period of time to perform the flushing operation on the second pump 100.

Further, the fluid used for flushing operation may be recycled in the system 10 according to the present disclosure. When the fluid inside the reservoir 40 is pumped using the first pump 30 towards the second pump 100, the filter 60 between the first pump 30 and second pump 100 may filter the fluid for separation of any contaminants from the fluid. The filter 60 cleans the fluid for flushing the fluid again through the second pump 100. Thus, the system 10 in accordance with present disclosure may require a lesser amount of fluid for effective flushing operation on the second pump 100.

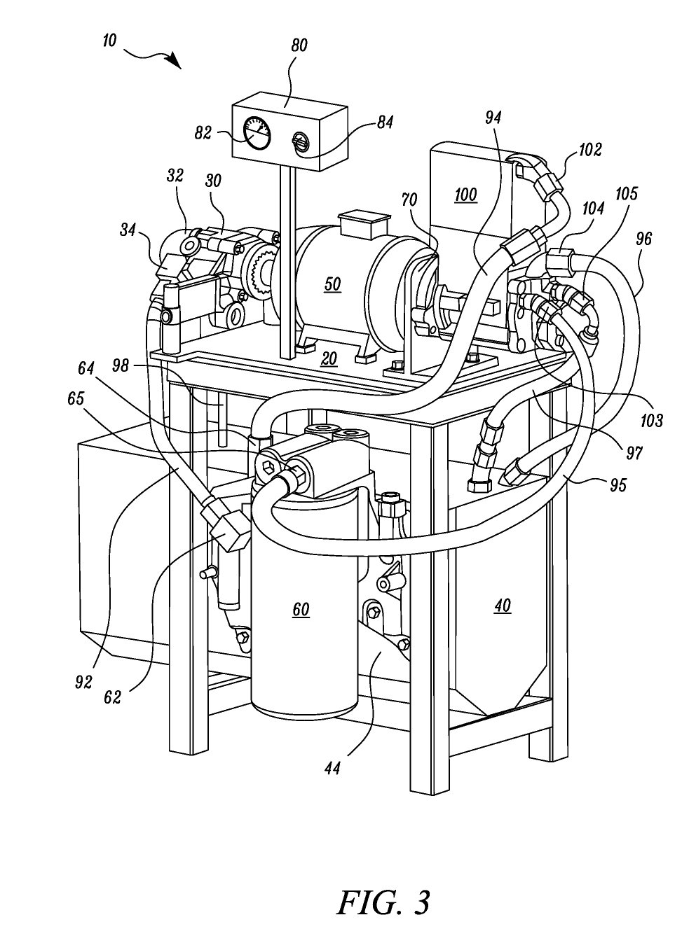

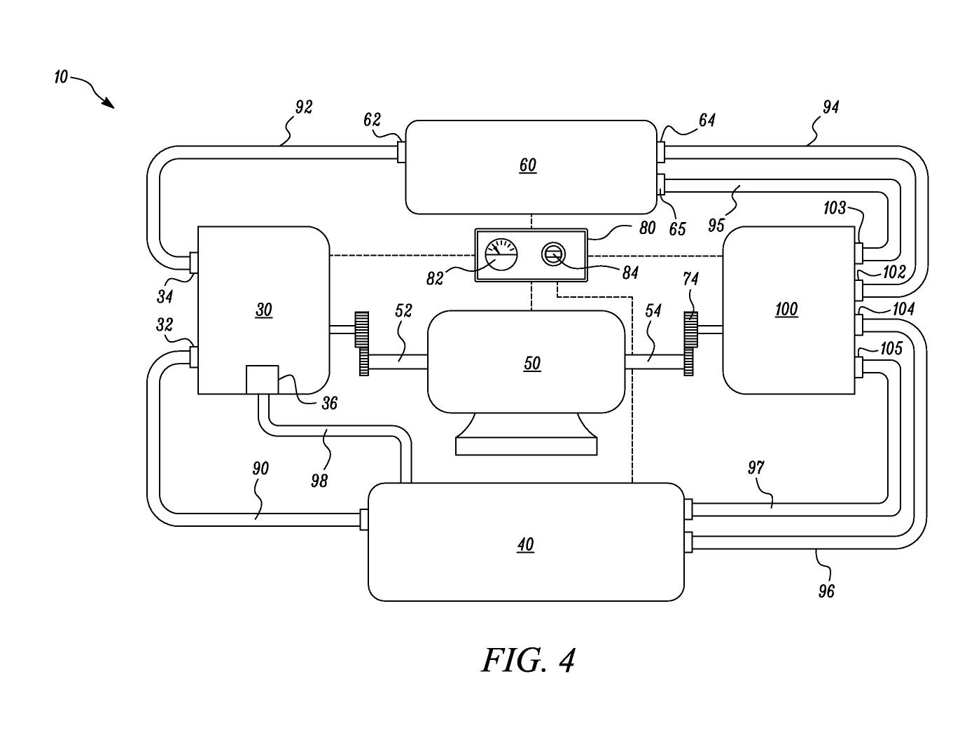

The system 10 may include multiple filter outlets for connection to a pump having multiple fluid inlets. In accordance with an embodiment as illustrated in FIG. 3 and FIG. 4, the system 10 may further include two filter outlets 64,65 to be coupled to a pump with two inlets, for example a high efficiency pump such as a fuel injection pump. In the embodiment as illustrated, two delivery conduits 94,95 couple the two filter outlets 64,65 with two second pump inlets 102,103. Further, the two second pump outlets 104,105 may be connected via two return conduits 96,97 to convey the fluid being flushed out from the second pump 100 to the reservoir 40.

In an embodiment as illustrated in FIG. 1-4, the system 10 may further have a control module 80 for controlling the operation of the system 10. The control module 80 may include various gauge displays 82 and control switches 84 coupled to various sensing or monitoring devices (not shown) in the system 10.

The control module 80 may be coupled to the components of the system 10 and the second pump 100 for controlling and monitoring the flushing operation. For example, the control module 80 may be coupled to the power source 50 to monitor and control the rotation speed of the first shaft 52 or the second shaft 54 of the power source 50. Further, the rotation speed of the shaft may be adjusted to control the rotation speed of the two pumps. Also, the control module 80 may be coupled to the reservoir 40, pumps 30,100 and the filter 60 to monitor and control the fluid flow in the system 10 or the second pump 100. For example, the pressure of the fluid supplied from the first pump 30 may be controlled by altering the rotation speed of the first pump 30.

Further, the system 10 may have a pressure relief mechanism. In the embodiment as illustrated in FIG. 2 and FIG. 4, the pressure relief mechanism may be a pressure relief valve 36 located in the first pump 30. The second pump 100 may be required to be flushed with the fluid at a certain predetermined pressure. The first pump 30 may be configured to supply fluid at a pressure higher than the predetermined pressure towards the second pump 100. The excess pressure or fluid flow generated by the first pump 30 may be relieved by the pressure relief valve 36. A weep conduit 98 may connect the outlet of the pressure relief valve 36 to the reservoir 40. The excess flow of the fluid pumped by the first pump 30 may be directed to the tank 40 using a pressure relief valve 39 coupled first pump 30. In an embodiment, the pressure relief valve may be coupled to the first pump 30 by placing the pressure relief valve in the supply conduit 92.

In an embodiment, the platform 20 may be the body of the reservoir 40. For example, the power source 50, the first pump 30, the filter 60 and the pump mounting structure 70 may be mounted on the body of the reservoir 40. The power source 50, the first pump 30 and the pump mounting structure 70 may be mounted on a top surface 42 of the reservoir 40 and the filter 60 may be mounted on a side surface 44 of the reservoir 40.

The platform 20 may be designed to be at height that is convenient for an operator to monitor and control the system 10. The reservoir 40 may be mounted below the platform 20. The filter 60 may also be located below the platform 20 on a side surface 44 of the reservoir 40. The power source 50, first pump 30 and the pump mounting structure 70 may be mounted on the platform 20. In an embodiment, the system 10 may have a casing for providing a covering for different components of the system 10. In another embodiment, the system 10 may have a casing for individual components for covering the components of the system 10.

### INDUSTRIAL APPLICABILITY

The present disclosure provides for a method 400 for flushing a pump. The step 402 includes pumping flushing fluid from a reservoir 40 using a first pump 30 to a second pump 100 for flushing the second pump 100. Step 404 includes driving the first pump 30 by a first driving shaft 52 of a power source 50 and driving the second pump 100 by the second driving shaft 54 of the power source 50.

In an embodiment, the method 400 may further include passing a portion of fluid pumped by the first pump 30 through a relief valve to the reservoir 40. In another embodiment, the method 400 may further include controlling the operation of the system 10 using a control module 80. In another embodiment, the method 400 may further include pumping the fluid received from the second pump 100 through the first pump 30, the filter 60, and back to the second pump 100.

Further, the system 10 in accordance with the present disclosure may be used for flushing different type of pumps. The pump flush device in accordance with present disclosure may provide for effective flushing of a pump with a lesser amount of fluid. Also, the system 10 in accordance with the present disclosure provides for a system 10 that is compact and easy to use.

The system 10 according to the present disclosure may provide for a pump flush system that can be used for flushing a number of different kinds of pumps. The system 10 in accordance with the present disclosure may further provide for an integrated system that can be used for flushing pumps.

What is claimed is:

1. A system for flushing a pump comprising:
a reservoir for a fluid;
a filter in fluid communication with the reservoir, the filter having an outlet for providing clean fluid to a pump for a flushing operation; and
a power source having a first driving shaft for pumping the fluid from the reservoir to the filter and a second driving shaft for driving the pump during the flushing operation.

2. The system of claim 1, further comprising a pump mounting structure for mounting a pump for a flushing operation.

3. The system of claim 2, wherein the pump mounting structure includes an adjustable bracket configured to accommodate pumps of more than one size.

4. The system of claim 1, further comprising a variable gear drive connected to one of the first driving shaft and the second driving shaft.

5. The system of claim 1, further comprising a first pump coupled to the first driving shaft for pumping the fluid from the reservoir to the filter.

6. A system for flushing a pump comprising:
a platform;
a reservoir for a fluid;
a filter in fluid communication with the reservoir, the filter having an outlet for providing clean fluid to a pump for a flushing operation;
a power source mounted on the platform and having a first driving shaft and a second driving shaft, the second driving shaft configured to drive a second pump for the flushing operation; and
a first pump connected to the first driving shaft for pumping the fluid from the reservoir to the filter for the flushing operation.

7. The system of claim 6 further comprising a pump mounting structure for mounting a pump for a flushing operation.

8. The system of claim 7, wherein the pump mounting structure includes an adjustable bracket configured to accommodate pumps of more than one size.

9. The system of claim 6, further comprising a variable gear drive connected to one of the first driving shaft and the second driving shaft.

10. The system of claim 6, further comprising a return conduit in fluid communication with the reservoir for receiving fluid after the flushing operation of the pump.

11. The system of claim 6, wherein the filter is mounted on the reservoir.

12. The system of claim 6, wherein the reservoir is placed under the platform.

13. The system of claim 6, wherein the platform is a top surface of the reservoir

14. The system of claim 6, further comprising a pressure relief valve disposed between the first pump and the filter configured to direct a portion of the fluid to the reservoir.

15. The system of claim 6, further comprising a control module for controlling operations of the system.

16. A method of flushing a pump comprising:
pumping flushing fluid from a reservoir to a filter for cleaning the fluid using a first pump;
conveying clean fluid from the filter to a second pump for its flushing operation;
driving the first pump by a first driving shaft of a power source and driving the second pump by a second driving shaft of the power source.

17. The method of claim 16, further comprising driving the first pump at a first speed and driving the second pump at a second speed.

18. The method of claim 16, further comprising pressurizing the fluid conveyed to the second pump.

19. The method of claim 16 further comprising returning fluid received after the flushing operation of a pump to the reservoir.

20. The method of claim 16, further comprising disconnecting the second pump from the second driving shaft after the flushing operation.
